(19) United States
(12) Patent Application Publication
(10) Pub. No.: US 2026/0357950 A1
(43) Pub. Date: Nov. 12, 2026

(54) SEALED AND THERMALLY INSULATING STRUCTURE

(71) Applicant: GAZTRANSPORT ET TECHNIGAZ, SAINT-REMY-LES-CHEVREUSE (FR)

(72) Inventors: Guillaume DE COMBARIEU, SAINT-REMY-LES-CHEVREUSE (FR); Benoît MOREL, SAINT-REMY-LES-CHEVREUSE (FR); Guillaume SALMON LEGAGNEUR, SAINT-REMY-LES-CHEVREUSE (FR)

(21) Appl. No.: 19/137,975

(22) PCT Filed: Dec. 8, 2023
(86) PCT No.: PCT/EP2023/084871

§ 371 Date: Jun. 11, 2025

(30) Foreign Application Priority Data
Dec. 16, 2022 (FR) FR2213706

(51) Int. Cl. F17C 3/08

(52) U.S. Cl. CPC F17C 3/08; F17C 2203/0337; F17C 2203/0391; F17C 2203/0629; F17C 2221/011; F17C 2221/012; F17C 2221/017; F17C 2223/0153; F17C 2270/0105

(57) ABSTRACT

The invention relates to a structure comprising: a first sealed wall (3) and a second sealed wall (2) located at a distance from the first sealed wall (3), an intermediate space (4) disposed between the first sealed wall (3) and the second sealed wall (2), in which the intermediate space (4) comprises: a porous separator (5); an extraction zone (7) located between the porous separator (5) and the second sealed wall (2), a granular zone (14) located between the porous separator (5) and the first sealed wall (3), the granular zone (14) being filled with a granular thermally insulating packing, in which the first porous separator has pores of a size smaller than the particle size of the granular insulating packing, in which the extraction zone exhibits a resistance to the passage of gas molecules that is lower than the resistance to the passage of gas molecules in the granular zone.

### TECHNICAL FIELD

The invention relates to the field of airtight and thermally insulating structures for the storage and/or transportation of liquefied gas at low temperature, such as a tank for transporting liquid hydrogen which is at approximately −253° C. at atmospheric pressure but can also be stored at a higher pressure. These tanks may be installed in fixed positions or on any land-based or floating vehicle.

### TECHNICAL BACKGROUND

Self-supporting tanks and membrane tanks for the storage and/or transportation of liquefied gas are known in the art.

In order to keep the gas in liquid form inside the tank, it is important for the tank to exhibit excellent thermal insulation properties, notably to limit the evaporation of the liquefied gas contained within the tank.

A tank comprises, for example, a double wall insulated with a granular insulating packing, such as perlite or glass microspheres. In a tank of this kind, the granular insulating packing fills the entire space between the double wall.

It is known from the document “Glass bubbles insulation for liquid hydrogen storage tanks, J. P. Sass, W. W. St. Cyr, T. M. Barrett, R. G. Baumgartner, J. W. Lott, and J. E. Fesmirel, June 30, 2009”, for example, that the pressure in the intermediate space of the double wall containing the granular insulating packing, in this case glass microspheres, can be reduced, in order to improve the thermal insulation properties of the tank.

However, the method of evacuating an intermediate space of this kind to create a vacuum by means of vacuum pumps is a lengthy and energy-intensive process due to the significant pressure losses generated by the granular insulating packing. In other words, it is difficult to extract all the air initially present in the intermediate space. By way of illustration, for a type C tank (within the meaning of the IGC code of the International Maritime Organization) with an intermediate space volume of 3500 m 3 filled with perlite, it takes 125 days of pumping to reach a pressure of 6 Pa in this space.

### SUMMARY OF THE INVENTION

One concept underlying the invention is to address the aforementioned problems.

Another concept underlying the invention is to provide an airtight structure comprising an intermediate space comprising a gas phase under vacuum, in order to achieve excellent thermal insulation properties.

Another concept underlying the invention is to provide an airtight and thermally insulating structure having an intermediate space that can be evacuated more quickly.

A further concept underlying the invention is to provide a method for evacuating an intermediate space of an airtight and thermally insulating structure and, in particular, one in which the evacuation is accelerated compared with currently known vacuum evacuation methods.

According to one embodiment, the invention provides an airtight and thermally insulating structure for the storage or transportation of a liquefied gas, the structure comprising:
a first airtight wall and a second airtight wall spaced apart from the first airtight wall, an intermediate thermally insulating space disposed between the first airtight wall and the second airtight wall, the intermediate space being suitable and intended to be placed under vacuum,
in which the intermediate space comprises:
a first porous separator;
a first extraction zone located between the first porous separator and the second airtight wall, a granular zone located between the first porous separator and the first airtight wall, the granular zone being filled with a granular thermally insulating packing,
in which the first porous separator has pores with a size smaller than the particle size of the granular insulating packing, in order to retain the granular thermally insulating packing within the granular zone,
in which the first extraction zone has a resistance to the passage of gas molecules that is lower than the resistance to the passage of gas molecules of the granular zone.

In other words, the first extraction zone has a resistance to the flow of gas molecules that is lower than that which would be present in an intermediate space entirely filled with granular thermally insulating packing and without any extraction zone.

Owing to these features, the structure exhibits excellent thermal insulation properties. Furthermore, thanks to a first extraction zone of this kind, the pressure losses in the intermediate space are reduced, thereby allowing faster evacuation. The gas phase in the intermediate space can thereby be evacuated and drawn off via a vacuum pump, which is advantageously connected to the first extraction zone. A structure of this kind makes it possible to significantly reduce the pumping time required to achieve a vacuum, reducing it from several months in the prior art to a few days with the present invention.

According to the invention, “particle size” refers to the mean size of the grains of the granular insulating packing, in other words, their mean equivalent diameter. Hence, “pores of a size smaller than the particle size of the granular insulating packing” means that the pores of the porous separator must have a size, for example a mean equivalent diameter, smaller than the mean equivalent diameter of the particles, thereby allowing the passage of the granular insulating packing through the porous separator into the extraction zone to be prevented.

According to embodiments, a structure of this kind may comprise one or more of the following features.

According to one embodiment, the first extraction zone comprises a first porous insulating layer, and the first porous insulating layer exhibits open, interconnected pores of a size greater than the size of the open pores of the granular thermally insulating packing, and the first porous insulating layer has a porosity greater than that of the granular thermally insulating packing. Hence, the pressure losses in the intermediate space are reduced, thereby enabling faster evacuation.

According to one embodiment, the first extraction zone does not comprise thermally insulating material. That is to say, the first extraction zone is not filled with material that increases resistance to the passage of gas molecules, apart from any possible means for securing the first porous separator.

According to one embodiment, the thickness of the extraction zone is at least 1 mm, preferably at least 10 mm, and more preferably at least 100 mm, for example between 100 mm and 500 mm.

According to one embodiment, the extraction zone has an open porosity greater than 96%.

According to one embodiment, the extraction zone has a Knudsen number (Kn) lower than the Knudsen number of the granular zone.

According to one embodiment, the extraction zone has a Kn less than or equal to 0.5, preferably less than 0.1, at 296 Kelvin (K), for a gas at the target pressure. According to one embodiment, the extraction zone has a Kn less than or equal to 0.5, preferably less than 0.1, at 296 Kelvin (K), for nitrogen, at a pressure between 10 and 200 Pa.

According to one embodiment, the granular insulating packing comprises grains having a mean equivalent diameter greater than 110% of the mean equivalent diameter of the pores of the porous separator.

According to one embodiment, the porous separator has a pore size distribution that allows clogging of the porous separator by the granular insulating packing with a cut-off threshold lower than 90%, preferably lower than 75%, and more preferably lower than 50%, of the mean grain diameter of the granular thermally insulating packing.

According to another embodiment, the porous separator has a cut-off threshold less than 50 um (micrometers), and preferably less than 15 μm.

According to one embodiment, the intermediate space comprises a second porous separator spaced apart from the first sealed wall, and a second extraction zone located between the second porous separator and the first sealed wall, the granular zone being located between the first porous separator and the second porous separator, In which the second porous separator has pores of a size smaller than the particle size of the granular insulating packing, in which the second extraction zone exhibits a resistance to the passage of gas molecules lower than the resistance to the passage of gas molecules of the granular zone.

In a variant, the second extraction zone comprises a second porous insulating layer, and the second porous insulating layer exhibits open, interconnected pores with a size greater than the size of the open pores of the granular thermally insulating packing, and the second porous insulating layer has a porosity greater than the porosity of the granular thermally insulating packing.

According to one embodiment, the second extraction zone does not comprise thermally insulating material. That is to say, the second extraction zone is not filled with material that increases resistance to the passage of gas molecules, apart from any possible means for securing the second porous separator.

According to one embodiment, the first porous separator comprises a sheet perforated through its thickness, an expanded metal sheet, a metal mesh, a composite material plate perforated through its thickness, or a composite material plate made of fibers bonded together and having an open porosity greater than 30% of its volume.

According to one embodiment, the second porous separator comprises a sheet perforated through its thickness, an expanded metal sheet, a metal mesh, a composite material plate perforated through its thickness, or a composite material plate made of fibers bonded together and having an open porosity greater than 30% of its volume.

According to one embodiment, the first porous separator or the second porous separator is fixed to one of the first and second sealed walls via fastening means. According to one embodiment, the fastening means are selected from bolts and rivets.

According to one embodiment, the first porous separator comprises a rigid mesh fixed to one of the first and second sealed walls.

According to one embodiment, the second porous separator comprises a rigid mesh fixed to one of the first and second sealed walls.

According to one embodiment, the mesh is a sheet perforated through its thickness, an expanded metal sheet, a metal mesh, a composite material plate perforated through its thickness, or a composite material plate made of fibers bonded together and having an open porosity greater than 30% of its volume.

According to one embodiment, the first porous separator or the second porous separator comprises a plurality of meshes.

According to one embodiment, the meshes of the plurality of meshes each comprise a central portion and two lateral portions projecting from each end of the central portion toward the first wall or the second wall. According to one embodiment, the two lateral portions project perpendicularly from the central portion.

According to one embodiment, the first porous separator comprises a textile covering the mesh and affixed to said mesh, the textile having pores of a size smaller than the particle size of the granular insulating packing.

According to one embodiment, the second porous separator comprises a textile covering the mesh and affixed to said mesh, the textile having pores of a size smaller than the particle size of the granular insulating packing.

According to one embodiment, the textile is fixed to the mesh by fastening means. According to one embodiment, the fastening means are selected from an adhesive strip, such as a Velcro®-type strip, glue, rivets, bolts, and sewn threads.

According to one embodiment, the textile is selected from:
a fabric based on polyethylene terephthalate (PET) fibers, mineral fibers such as glass fibers, and metallic fibers;
paper based on mineral fibers;
a web or non-woven felt made from polymer fibers, such as PET or polypropylene, or from mineral fibers such as glass fiber.

According to one embodiment, the textile has a filtration threshold of less than 30 μm, and more preferably less than 15 μm.

According to one embodiment, the first insulating layer comprises glass wool.

According to one embodiment, the second insulating layer comprises glass wool.

According to one embodiment, the glass wool has a pore size of between 0.5 mm and 2 mm. According to one embodiment, the glass wool has a porosity in the range of between 98% and 99.5%.

According to one embodiment, the granular thermally insulating packing is selected from perlite, hollow glass microspheres, fumed silica, granular aerogels such as silica aerogels, or a mixture of at least two of these materials.

According to one embodiment, the granular thermally insulating packing has an open porosity level of less than 97%, or less than 75%, or less than 45%.

According to one embodiment, the granular aerogel has an open porosity level of between 94% and 97%.

According to one embodiment, the perlite has an open porosity level of between 75% and 97%.

According to one embodiment, the fumed silica has an open porosity level of between 94% and 97%.

According to one embodiment, the glass microspheres have an open porosity level of between 30% and 45%.

According to one embodiment, the granular thermally insulating packing has a particle size of less than 4000 μm, preferably less than 2000 μm.

According to one embodiment, the perlite has a particle size greater than 50 μm, for example a particle size of between 500 and 1500 μm.

According to one embodiment, the granular aerogel has a particle size greater than 50 μm, for example a mean diameter of between 1000 and 2000 μm.

According to one embodiment, the hollow glass microspheres have a diameter greater than 30 μm and a mean diameter of 65 μm. For example, reference K1 from the company 3M, 90% of which have a diameter greater than 30 μm with a mean diameter of 65 μm, may be used.

According to one embodiment, the fumed silica comprises agglomerates larger than 200 μm. According to one embodiment, the structure comprises a vacuum pump connected to the first extraction zone.

According to one embodiment, the structure comprises a vacuum pump connected to the second extraction zone.

According to one embodiment, the intermediate space has a gas phase at an absolute pressure of less than 10 Pa, preferably less than 1 Pa, when the structure is filled with liquefied gas.

The pressure indicated above is the final pressure required once the internal space defined by the first sealed wall is filled with the liquefied gas. This pressure is achieved by combining continuous operation of the vacuum pump and cryopumping of a portion of the residual gases onto the cold wall.

According to one embodiment, the first sealed wall is intended to be in contact with the liquefied gas, and the second sealed wall is disposed outside the first sealed wall.

According to one embodiment, the structure is in the form of a tank intended to store liquefied gas.

According to one embodiment, the tank is a self-supporting tank.

According to one embodiment of the self-supporting tank, the second sealed wall and the first sealed wall are self-supporting, the second sealed wall and the first sealed wall being supported by a supporting member, said supporting member passing through the second sealed wall to support the first sealed wall.

According to another embodiment, the tank is a membrane tank, the second sealed wall being a load-bearing structure and the first sealed wall being a sealed membrane supported by a plurality of support elements positioned in the intermediate space and extending between the second sealed wall and the first sealed wall.

According to one embodiment, the plurality of support elements comprises support pillars.

According to one embodiment, the structure is in the form of a pipeline intended to transport liquefied gas.

According to one embodiment of the structure in the form of a pipeline, the first sealed wall and the second sealed wall extend in a longitudinal direction of the structure, the first sealed wall forming an internal space intended to be in contact with the liquefied gas, said internal space comprising a through-hole extending in the longitudinal direction of the structure from a first longitudinal end of the structure to a second longitudinal end of the structure, so as to allow the transportation of a liquefied gas.

According to one embodiment, the gas phase in the intermediate space is at an absolute pressure of less than 300 Pa, and preferably less than 100 Pa, prior to the cooling and filling of the internal space with the liquefied gas.

This refers to the maximum pressure defined at ambient temperature before the internal tank is cooled and filled with the liquefied gas. This pressure level allows the thermal conductivity of the granular insulating packing to be reduced by 50% to 90% of its initial conductivity when placed in an insulating space atmosphere of 1.105 Pa. This reduction in thermal conductivity therefore makes it possible to initiate cooling and filling with the liquefied gas while limiting the evaporation rate of said liquefied gas caused by the cooling of the tank.

According to one embodiment, the liquefied gas is selected from: liquefied natural gas (LNG), helium, oxygen (LOx), argon, and preferably hydrogen (LH₂).

According to one embodiment, the invention also provides a method for evacuating a sealed and thermally insulating structure for storing or transporting a liquefied gas, said method comprising:
providing a sealed and thermally insulating structure for the storage or transportation of a liquefied gas, the structure comprising:
a first sealed wall, the first sealed wall forming an internal space intended to be in contact with the liquefied gas;
a second sealed wall located at a distance from the first sealed wall;
a thermally insulating intermediate space disposed between the first sealed wall and the second sealed wall,
in which the intermediate space exhibits a gas phase and comprises:
a first porous separator;
a first extraction zone located between the first porous separator and the second sealed wall;
a granular zone located between the first porous separator and the first sealed wall, the granular zone being filled with a granular thermally insulating packing,
in which the first porous separator has pores of a size smaller than the particle size of the granular insulating packing, so as to retain the granular thermally insulating packing within the granular zone;
and in which the first extraction zone exhibits a resistance to the passage of gas molecules that is lower than the resistance to the passage of gas molecules in the granular zone; and
lowering the pressure in the intermediate space by means of a vacuum pump connected to the first extraction zone until the gas phase in the intermediate space reaches an absolute pressure of less than 200 Pa, preferably less than 50 Pa, and more preferably less than 10 Pa prior to cooling and filling of the internal space with the liquefied gas.

According to one embodiment of the method, the structure comprises a second extraction zone such as that described above, and the method further comprises:
lowering the pressure in the intermediate space by means of a vacuum pump opening into the second extraction zone until the gas phase in the intermediate space reaches an absolute pressure lower than 200 Pa, preferably lower than 100 Pa, prior to cooling and filling of the internal space with the liquefied gas, so as to obtain a structure such as that described above.

According to one embodiment of the method, the pressure in the intermediate space is reduced to a pressure lower than 50 Pa, and preferably lower than 10 Pa.

According to an advantageous embodiment of the method, a cryopumping effect is used, in addition to the aforementioned vacuum pump, to achieve the target vacuum level in the intermediate space.

According to one embodiment of the method, prior to being evacuated, the intermediate space is filled with an inert gas having a solid condensation temperature higher than the liquefaction temperature of the liquefied gas stored in the structure. For example, when the liquefied gas stored in the tank is liquid hydrogen, the inert gas may be carbon dioxide. Hence, given the temperature of the hydrogen in its liquid state, the carbon dioxide present in the intermediate space condenses into the solid state within the intermediate space, thereby contributing to a reduction in the pressure therein.

According to one embodiment, the invention also provides a ship for transporting liquefied gas, said ship comprising a structure as previously described.

According to one embodiment, the invention also provides a transfer system for transferring liquefied gas, the system comprising the aforementioned ship, insulated pipelines arranged to connect the structure installed in the hull of the ship to a floating or land-based storage facility and a pump configured to drive liquefied gas through the insulated pipelines from or to the floating or land-based storage facility to or from the structure of the ship.

According to one embodiment, the invention also provides a method for loading or unloading a ship as described above, in which liquefied gas is conveyed through insulated pipelines from or to a floating or land-based storage facility to or from the structure of the ship.

According to one embodiment, the aforementioned transfer system for transferring liquefied gas, or the aforementioned method for loading or unloading, is such that at least one of the insulated pipelines is a structure in the form of a pipeline as previously described.

### BRIEF DESCRIPTION OF THE FIGURES

The invention will be better understood, and other objects, details, characteristics, and advantages thereof will become clearer from the following description of several specific embodiments of the invention, given solely by way of illustration and without limitation, with reference to the accompanying drawings.

FIG. 1 is a cutaway view of a self-supporting structure according to one embodiment.

FIG. 2 is a sectional view of a structure according to another embodiment in the form of a membrane tank.

FIG. 3 is a sectional view along an axis perpendicular to the longitudinal direction of a structure according to another embodiment in the form of a pipeline.

FIG. 4 is a schematic cutaway representation of a ship structure and a loading/unloading terminal for this structure.

FIG. 5 is an enlarged sectional view of zone I shown in FIG. 1, according to one embodiment.

FIG. 6 illustrates a top view of the embodiment in FIG. 5.

FIG. 7 is an enlarged sectional view of zone I shown in FIG. 1, according to another embodiment.

FIG. 8 illustrates a top view of the embodiment in FIG. 7.

FIG. 9 is an enlarged sectional view of zone I shown in FIG. 1, according to another embodiment.

### DESCRIPTION OF THE EMBODIMENTS

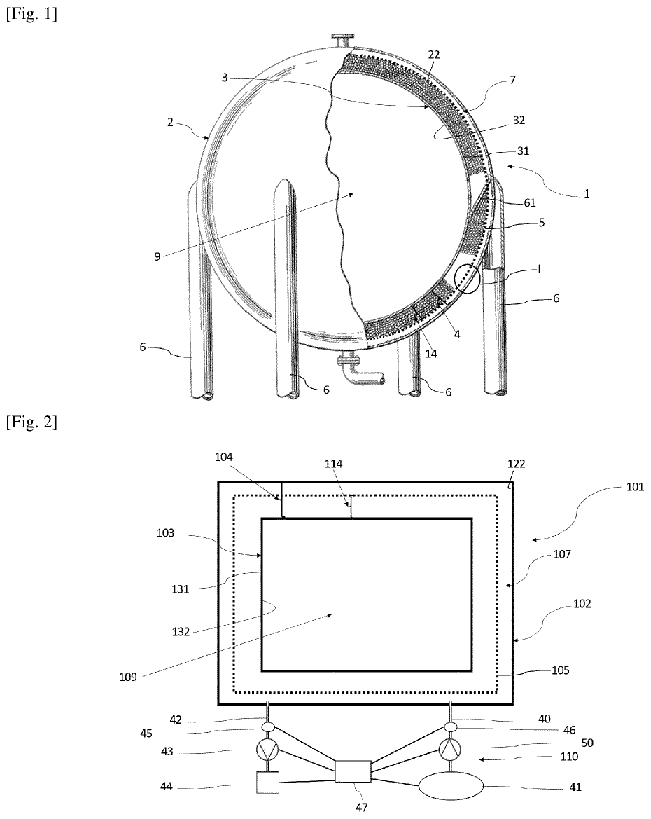

A first embodiment is illustrated in FIG. 1 and shows a sealed and thermally insulating structure 1 for storing liquefied gas. The structure takes the form of a self-supporting tank.

The structure 1 comprises a first sealed wall 3, a second sealed wall 2, and a porous separator 5 located between the first sealed wall 3 and the second sealed wall 2. The second sealed wall 2 is located on the outside of the first sealed wall 3.

The first sealed wall 3 is located at a distance from an inner surface 22 of the second sealed wall 2. The first sealed wall 3 has an inner surface 32 defining an internal space 9 intended for storing the liquefied gas, such as liquid hydrogen.

The first sealed wall 3 has an outer surface 31, which, together with the inner surface 22 of the outer sealed wall 2, defines an intermediate space 4 that is thermally insulating and under vacuum.

The second sealed wall 2 and the first sealed wall 3 are self-supporting, in other words, they are rigid and maintain their structure by counterbalancing their own weight. The second sealed wall 2 and the first sealed wall 3 are supported by supporting members 6, for example, by beams. The supporting member 6 comprises a spacer 61 extending through the intermediate space 4 to support the first sealed wall 3.

The intermediate space 4 comprises the porous separator 5 which is spaced apart from the inner surface 22 of the second sealed wall 2 and fixed to the second sealed wall 2. The method of attachment of the porous separator will be described in greater detail below.

### The Porous Separator Comprises, for Example, a Mesh, a Textile, or a Combination of a Mesh and a textile.

The intermediate space 4 further comprises an extraction zone 7 located between the first porous separator 5 and the inner surface 22 of the second sealed wall 2. The extraction zone 7 is intended to be evacuated via a vacuum pump (not shown), in order to place the entire intermediate space 4 under vacuum. For this purpose, the extraction zone 7 is connected to the vacuum pump by a duct 17, as illustrated in FIG. 1.

The intermediate space 4 comprises a granular zone 14 located between the porous separator 5 and the outer surface 31 of the inner sealed wall 3, the granular zone 14 is filled with a granular thermally insulating packing, for example perlite, hollow glass microspheres, fumed silica, silica aerogels, or a mixture of at least two of these examples.

The extraction zone 7 comprises a layer of porous thermal insulation, for example a layer of glass wool, arranged between the porous separator 5 and the inner surface 22 of the second sealed wall 3.

The porous separator 5 has pores of a size smaller than the particle size of the granular insulating packing, in order to retain the granular thermally insulating packing within the granular zone 14.

In a variant that is not shown and is similar to FIG. 1, the intermediate space 14 of FIG. 1 comprises a second porous separator spaced from the outer surface 31 of the first sealed wall 3 and fixed to the first sealed wall 3, and a second extraction zone located between the second porous separator and the outer surface 31 of the first sealed wall 3. The granular zone 14 is located between the porous separator 5 and the second porous separator, the second extraction zone comprises a second porous insulating layer retained between the second porous separator and the outer surface 31 of the first sealed wall 3. The second porous separator, in a similar manner to the porous separator 5, has pores of a size smaller than the particle size of the granular insulating packing, whereas the second porous insulating layer has pores of a size greater than the particle size of the granular insulating packing.

Advantageously, the thickness of the extraction zones is at least 1 mm, preferably at least 10 mm, and more preferably at least 100 mm.

In a variant that is not shown, the extraction zone does not comprise thermally insulating material.

For the other embodiments shown in FIGS. 2 and 5 to 9, identical or similar elements bear the same reference numerals as those described in connection with FIG. 1, increased by 100. They will be described only to the extent that they differ from those previously described.

In the embodiment illustrated in FIG. 2, the structure takes the form of a membrane tank, for example having a polyhedral shape.

The first sealed wall 103 of the structure 101 is a sealed membrane, for example a corrugated metal membrane or a metal membrane having a continuous sheet of strakes. The sealed membrane is supported by a plurality of support elements (not shown), for example support pillars positioned in the intermediate space 104 and extending between the second sealed wall 102 and the first sealed wall 103.

The metal membrane is, for example, made of Invar®, in other words, an iron-nickel alloy with a coefficient of thermal expansion typically between 1.2×10 6 and 2×10⁻⁶ K⁻.

According to a variant, the second wall 102 is a sealed membrane. In this case, the first sealed wall 103 is a primary sealed membrane, i.e. intended to be in contact with the liquefied gas contained in the internal space 109, and the second wall is a secondary sealed membrane.

According to another variant, the structure comprises a plurality of additional walls so as to form a multilayer structure, such as a membrane tank incorporating one or more of the embodiments previously described.

In a variant that is not shown and is similar to that in FIG. 2, the intermediate space 104 of FIG. 2 comprises a second porous separator spaced apart from the outer surface 131 of the first sealed wall 103 and fixed to the first sealed wall 103, and a second extraction zone located between the second porous separator and the outer surface 131 of the first sealed wall 103. The granular zone 114 is located between the porous separator 105 and the second porous separator. The second extraction zone comprises a second porous insulating layer retained between the second porous separator and the outer surface 31 of the first sealed wall 3. The second porous separator, in a similar manner to the porous separator 105, has pore sizes that are smaller than the particle size of the granular insulating packing.

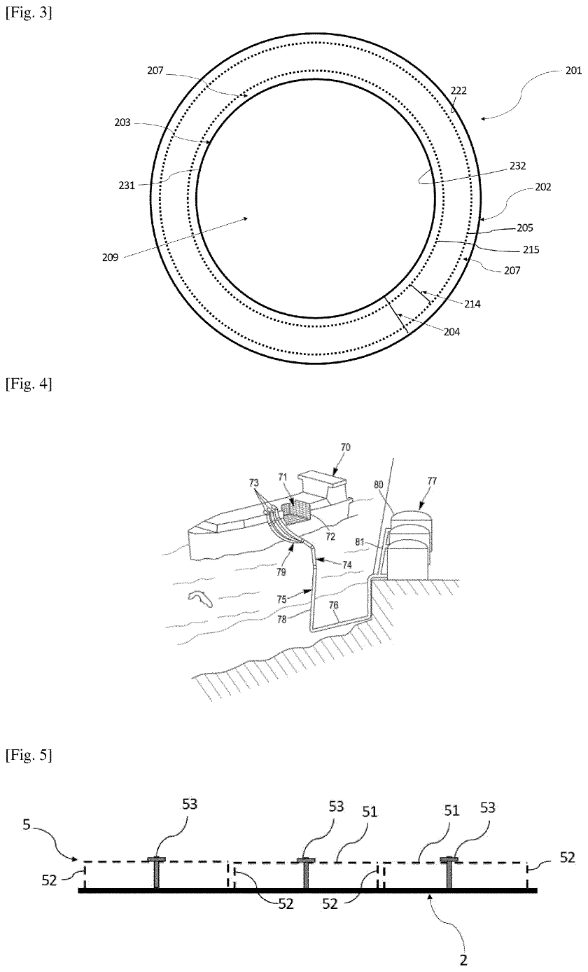

According to another embodiment, the structure 201 illustrated in FIG. 3 takes the form of a cylindrical pipeline intended for transporting liquefied gas.

According to this variant, the first sealed wall 203, the second sealed wall 202, and the internal space 209 extend along a longitudinal direction of the structure 201, the internal space 209 comprising a through-opening extending along the longitudinal direction of the structure 201 from a first longitudinal end of the structure 201 to a second longitudinal end of the structure 201. The through-opening allows the transportation of liquefied gas from the first longitudinal end of the structure 201 to the second longitudinal end of the structure 201, and vice versa.

The intermediate space 214 of the structure 201 further comprises a second porous separator 215 spaced apart from the outer surface 231 of the first sealed wall 203 and fixed to the first sealed wall 203. A second extraction zone 207 is located between the second porous separator 215 and the outer surface 231 of the first sealed wall 203.

The granular zone 214 is located between the first porous separator 205 and the second porous separator 215.

In a similar manner to what has been described previously, the second extraction zone 207 comprises a second porous insulating layer retained between the second porous separator 215 and the outer surface 231 of the first sealed wall 203 and the pore size of the second porous separator 215 is smaller than the particle size of the granular insulating packing.

In a variant that is not shown and is similar to FIG. 3, the structure 201 comprises a single porous separator, namely the porous separator 205, which is fixed to the second sealed wall 202.

Various embodiments of the porous separator 5 are described below using FIGS. 5 to 9.

The porous separator 5 as illustrated in FIGS. 5 and 6 comprises a rigid mesh having a central portion 51 located at a distance from, and parallel to, the second sealed wall 2, as well as at least two lateral portions 52 protruding perpendicularly from the central portion 51 in the direction of the second sealed wall 2 and having an end bearing against the second sealed wall 2. The porous separator 5 is fixed to the second sealed wall 2 via fastening means 53, such as a bolt or a rivet fixed to the second sealed wall 2.

When a plurality of small-sized meshes is juxtaposed side by side, a single central fastening per mesh is sufficient, as shown in FIG. 6.

The spacing between each mesh is of such a size as to prevent the granular thermally insulating packing from passing through.

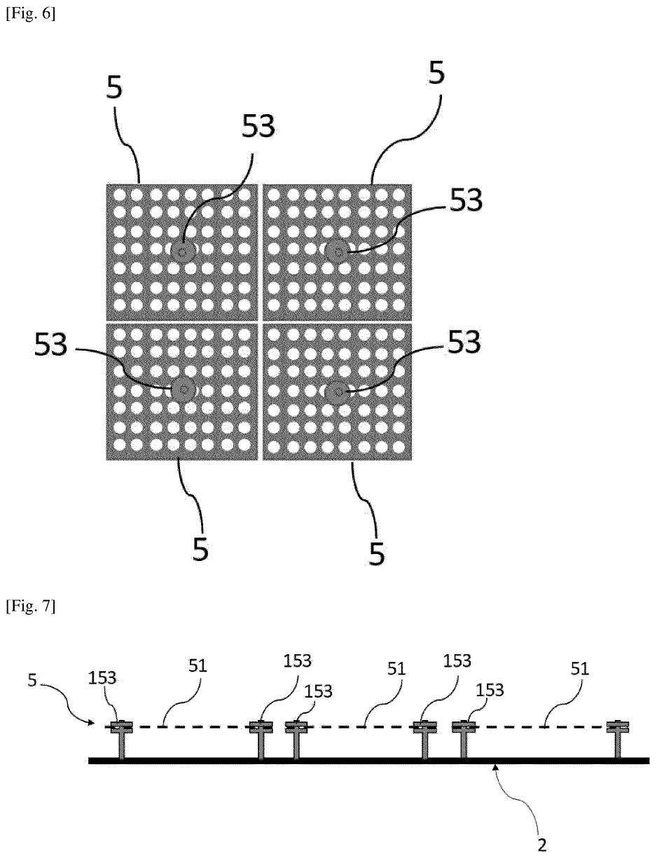

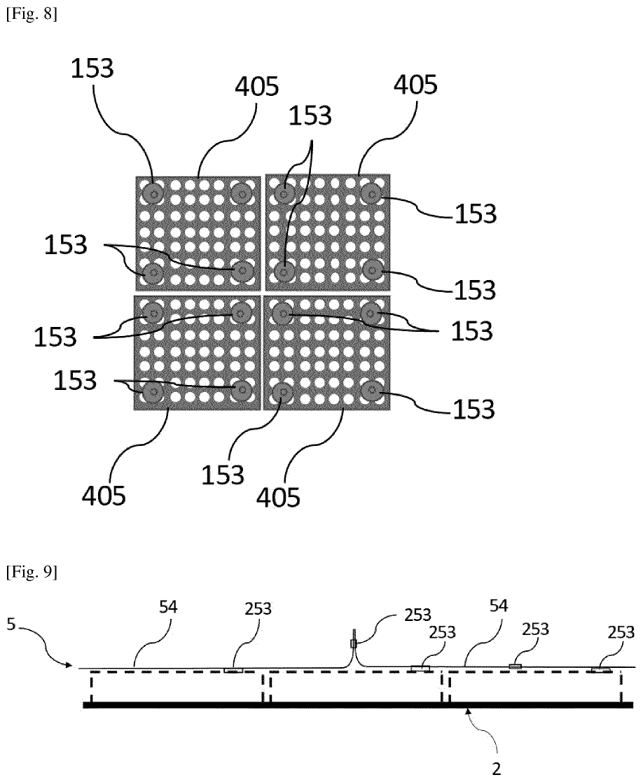

According to a variant of the porous separator 5 illustrated in FIGS. 7 and 8, the porous separator 5 does not have lateral portions resting against the second sealed wall 2, as is the case in FIG. 5. In this embodiment, the porous separator 5 is fixed to the second sealed wall 2 via support-type fastening means 153 positioned at the four corners of each mesh, for example. The fastening means 153 each comprise, for example, an anchor rod secured to the second sealing wall 2 and two fastening washers sandwiching the porous separator 5, so as to both secure the mesh and keep it at a distance from the second sealed wall 2. According to a variant embodiment shown in FIG. 9, the porous separator 5 comprises a textile 54 covering the mesh and fixed to said mesh. The fixing of the textile to the mesh is achieved, for example, by means of an adhesive strip positioned between the mesh and the textile. When multiple textiles 54 are used, the textiles are secured to one another, for example by stitching.

A method for evacuating an intermediate space of a structure according to one embodiment will be described below with reference to FIG. 2.

The management of the gas phase in the intermediate space 104 is carried out via a gas management system 110.

The gas management system 110 comprises a suction line 42 connected to a vacuum pump 43 and opening out into the extraction zone 107. Pressure sensors (not shown) are arranged in the extraction zone 107 and in the granular zone 114.

In order to evacuate the intermediate space 104, the vacuum pump is activated until the gas phase in the intermediate space 104 reaches an absolute pressure lower than 300 Pa, and preferably lower than 100 Pa, prior to cooling and filling of the internal space with the liquefied gas.

In order to manage the gas phase present in the intermediate space 104, the gas management system 110 may further comprise a supply line 40 connected to a gas source 41 and to a compressor 50, and opening out into the extraction zone 107. A gas management system of this kind may be useful for the monitoring or for the internal gas purging of the intermediate space 104.

The gas management system 110 may also comprise various components for controlling and monitoring the injection and/or suction of gas, as shown in FIG. 2.

For example, the gas management system 110 comprises one or more devices selected from:
a gas analyzer 44 for the gas extracted via the suction line 42,
an outlet gas flow meter 45, an inlet gas flow meter 46,
a control unit 47,
a temperature sensor 49 located in the intermediate space 104.

In a variant of the method which is not shown, the gas management system 110 further comprises a second suction line (not shown), connected to the vacuum pump 43 or to another vacuum pump and opening out into a second extraction zone such as that previously described, for example in the case of a method of this kind applied to the second embodiment illustrated in FIG. 3, the second suction line opens out into the second extraction zone 207.

A configuration of this kind, with suction applied in both the first extraction zone and the second extraction zone, has the advantage of further accelerating the evacuation of the intermediate space and, more specifically, of the granular zone 214, which is filled with granular thermally insulating packing and may therefore be difficult and time-consuming to evacuate.

Similarly, in order to manage the gas phase present in the intermediate space 104, the gas management system 110 may also comprise a supply line 40 connected to a gas source 41 and to a compressor 50 and opening out into the second extraction zone, for example the second extraction zone 207 in the embodiment illustrated in FIG. 3.

The different variants of this method may be adapted and applied in a similar manner to the previously described embodiments.

With reference to FIG. 4, a cutaway view of a hydrogen carrier 70 shows a tank-shaped, sealed and insulated structure 71 of generally prismatic shape installed within the double hull 72 of the ship. The wall of the structure 71 comprises a primary sealed barrier intended to be in contact with the liquid hydrogen (LH₂) contained in the structure, a secondary sealed barrier arranged between the primary sealed barrier and the double hull 72 of the ship, and two insulating barriers arranged between the primary sealed barrier and the secondary sealed barrier, and between the secondary sealed barrier and the double hull 72, respectively.

As is known per se, loading/unloading pipelines 73 arranged on the upper deck of the ship may be connected, by means of appropriate connectors, to a marine or port terminal, in order to transfer a load of hydrogen to or from the structure 71.

FIG. 4 shows an example of a marine terminal comprising a loading and unloading station 75, an undersea pipeline 76, and an onshore installation 77. The loading and unloading station 75 is a fixed offshore facility comprising a movable arm 74 and a tower 78 that supports the movable arm 74. The movable arm 74 carries a bundle of insulated flexible tubing 79 that can be connected to the loading/unloading pipelines 73. The adjustable movable arm 74 can adapt to any configuration of the hydrogen carrier. A connecting conduit (not shown) extends inside the tower 78. The loading and unloading station 75 enables the loading and unloading of the hydrogen carrier 70 from or to the onshore installation 77. The onshore installation 77 comprises tanks for storing liquefied gas 80 and connecting pipelines 81 that are connected to the loading/unloading station 75 via the undersea pipeline 76. The undersea pipeline 76 allows the transfer of liquefied gas between the loading/unloading station 75 and the onshore installation 77 over a long distance, for example 5 km, allowing the hydrogen carrier 70 to remain far offshore during loading and unloading operations.

To generate the pressure required for transferring the liquefied gas, pumps installed aboard the carrier 70 and/or pumps installed in the onshore installation 77 and/or pumps installed at the loading and unloading station 75 are operated.

Although the invention has been described in connection with several particular embodiments, it is obvious that it is not limited to these and encompasses all technical equivalents of the means described, as well as any combinations thereof falling within the scope of the invention. For example, the first sealed wall and the second sealed wall may be interchanged.

The use of the verbs “comprise,” “include,” or “contain,” and their conjugated forms, does not exclude the presence of elements or steps other than those stated in a claim.

In the claims, any reference sign in parentheses shall not be construed as limiting the scope of the claim.

1. An airtight and thermally insulating structure for the storage or transportation of a liquefied gas selected from: liquefied natural gas, helium, oxygen, argon, and hydrogen, the structure (1, 101, 201) comprising:
a first sealed wall (3, 103, 203), and a second sealed wall (2, 102, 202) located at a distance from the first sealed wall (3, 103, 203),
a thermally insulating intermediate space (4, 104, 204) disposed between the first sealed wall (3, 103, 203) and the second sealed wall (2, 102, 202), the intermediate space (4, 104, 204) being suitable and intended to be placed under vacuum,
wherein the intermediate space (4, 104, 204) comprises:
a first porous separator (5, 105, 205);
a first extraction zone (7, 107, 207) located between the first porous separator (5, 105, 205) and the second sealed wall (2, 102, 202),
a granular zone (4, 114, 214) located between the first porous separator (5, 105, 205) and the first sealed wall (3, 103, 203), the granular zone (14, 114, 214) being filled with a granular thermally insulating packing,
wherein the first porous separator (5, 105, 205) has pores of a size smaller than the particle size of the granular insulating packing, so as to retain the granular thermally insulating packing within the granular zone (14, 114, 214), and the first extraction zone (7, 107, 207) exhibits a resistance to the passage of gas molecules that is lower than the resistance to the passage of gas molecules in the granular zone (14, 114, 214), wherein the first extraction zone (7, 107, 207) comprises a first porous insulating layer,
wherein the first porous insulating layer exhibits open, interconnected pores of a size greater than the size of the open pores of the granular thermally insulating packing, and the first porous insulating layer has a porosity greater than that of the granular thermally insulating packing, and
wherein the first porous separator (5, 105, 205) comprises a rigid mesh fixed to one of the first and second sealed walls.

2. The structure as claimed in claim 1, in which the intermediate space (204) comprises a second porous separator (215) spaced apart from first sealed wall (203), and a second extraction zone (207) located between the second porous separator (215) and the first sealed wall (203), the granular zone (214) being located between the first porous separator (205) and the second porous separator (215), wherein the second porous separator (215) has pores of a size smaller than the particle size of the granular insulating packing, wherein the second extraction zone (207) exhibits a resistance to the passage of gas molecules lower than the resistance to the passage of gas molecules of the granular zone (14, 114, 214).

3. The structure as claimed in claim 2, in which the second extraction zone comprises a second porous insulating layer, wherein the second porous insulating layer exhibits open, interconnected pores with a size greater than the size of the open pores of the granular thermally insulating packing, and the second porous insulating layer has a porosity greater than the porosity of the granular thermally insulating packing.

4. The structure as claimed in claim 1, wherein the first porous separator (5, 105, 205) comprises a textile covering the mesh and affixed to said mesh, the textile having pores of a size smaller than the particle size of the granular insulating packing.

5. The structure as claimed in claim 1, in wherein the granular thermally insulating packing has a particle size of less than 4000 μm.

6. The structure as claimed in claim 1, comprising a vacuum pump (43) connected to the first extraction zone (7, 107, 207).

7. The structure as claimed in claim 1, wherein the intermediate space has a gas phase at an absolute pressure of less than 300 Pa.

8. The structure as claimed in claim 1, wherein the granular insulating packing is selected from perlite, hollow glass microspheres, fumed silica, and silica aerogels.

9. The structure as claimed in claim 1, wherein the first porous insulating layer comprises glass wool.

10. The structure as claimed in claim 1, wherein the first porous separator (5, 105, 205) is chosen from a sheet perforated through its thickness, an expanded metal sheet, a metal mesh, a composite material plate perforated through its thickness, a composite material plate made of fibers bonded together and having an open porosity greater than 30% of its volume.

11. The structure as claimed in claim 1, in wherein the first première sealed wall (3, 103, 203) is intended to be in contact with the liquefied gas and the second sealed wall (2, 102, 202) is disposed on the outside of the first sealed wall (3, 103, 203).

12. The structure as claimed in claim 1, the structure being in the form of a tank intended to store liquefied gas.

13. The structure as claimed in claim 1, the structure being in the form of a pipeline intended to transport liquefied gas.

14. A method for evacuating a sealed and thermally insulating structure for storing or transporting a liquefied gas, said method comprising:
providing a structure as claimed in claim 1, and
lowering the pressure in the intermediate space (14, 114, 214) by means of a vacuum pump (43) connected to the first extraction zone (7, 107, 207) until the gas phase in the intermediate space (4, 104, 204) reaches an absolute pressure of less than 200 Pa, prior to cooling and filling of the internal space of the sealed structure with the liquefied gas.

15. A ship (70) for transporting liquefied gas, said ship comprising a structure (71) as claimed in claim 1.

16. A transfer system for transferring liquefied gas, the system comprising a ship (70) as claimed in claim 15, insulated pipelines (73, 79, 76, 81) arranged to connect the structure (71) installed in the hull of the ship to a floating or land-based storage facility (77) and a pump configured to drive liquefied gas through the insulated pipelines from or to the floating or land-based storage facility to or from the structure of the ship.

17. A method for loading or unloading a ship (70) as claimed in claim 15, in which liquefied gas is conveyed through insulated pipelines (73, 79, 76, 81) from or to a floating or land-based storage facility (77) to or from the structure (71) of the ship (70).

18. The structure as claimed in claim 1, wherein the granular thermally insulating packing has a particle size of less than 2000 μm.

19. A method for evacuating a sealed and thermally insulating structure for storing or transporting a liquefied gas, said method comprising:
providing a structure as claimed in claim 1, and
lowering the pressure in the intermediate space (14, 114, 214) by means of a vacuum pump (43) connected to the first extraction zone (7, 107, 207) until the gas phase in the intermediate space (4, 104, 204) reaches an absolute pressure of less than 100 Pa prior to cooling and filling of the internal space of the sealed structure with the liquefied gas.
